(19) United States
(12) Patent Application Publication
(10) Pub. No.: US 2011/0168622 A1
(43) Pub. Date: Jul. 14, 2011

(54) High Efficiency, High Capacity Filter Media

(75) Inventor: Daniel LUCAS, Fayetteville, NC (US)

(73) Assignee: Purolator Filters NA LLC, Fayetteville, NC (US)

(21) Appl. No.: 12/685,828

(22) Filed: Jan. 12, 2010

(51) Int. Cl. B01D 29/46

(52) U.S. Cl. 210/490

(57) ABSTRACT

A high efficiency, high capacity fluid filter element that is suitable for meeting stringent cleanliness requirements has multiple filter layers. These layers include a cellulose and glass fiber first layer, a water repellant polybutylene terepthalate meltblown second layer, and a protective third layer providing structural support to the first and second layers. By way of an appropriate production procedure, the first, second, and third layers are laminated to define the filter element.

### BACKGROUND OF THE INVENTION

1. Field of the Invention

A media grade having high efficiency and high capacity for filtering fluids such as fuel is provided. The media grade is suitable for and meets stringent fuel cleanliness requirements.

2. Description of Related Art

U.S. Patent Application Publication 2002/0056684 to Klein discloses a multi-layer filter element in which all individual filter layers are made of synthetic fibers and at least one such layer is a meltblown fiber nonwoven web.

Filter elements with meltblown components are also known from numerous U.S. patents, including U.S. Pat. Nos. 6,211,100 to Legare, 6,274,041 to Williamson et al., and 6,322,604 to Midkiff, as well as from various published U.S. patent applications, including U.S. Patent Application Publications 2001/0040136 to Wei et al., 2002/0187701 and 2003/0203696 to Healey, 2005/0150385 to Huang et al., 2006/0163137 to Patil et al., 2007/0232177 to Imes et al., 2008/0105612 to Chappas, 2008/0142433 to McManus et al., 2008/0230471 to Tamada et al., 2009/0039028 to Eaton et al., and 2009/0120048 to Wertz et al.

### SUMMARY OF THE INVENTION

An analysis of North American Free Trade Agreement (NAFTA) specifications indicates that finer filter media grades will be needed for NAFTA original equipment manufacturers (OEMs). NAFTA requirements for cleanliness, particle separation efficiency, water separation efficiency, and dust holding capacity are all higher than in Europe. European grade filters neither meet the requirements mentioned nor address the specifications noted. General Motors (GM) filter specifications for the United States, for example, require 99.5% initial filtration efficiency at a 4 μm(c) particle size when tested according to ISO 19438. Accordingly, a new filter media concept is required.

One such new media filter is provided according to the invention, which concerns a high efficiency, high capacity fluid filter element, suitable for meeting stringent cleanliness requirements, having multiple filter layers. These layers include a cellulose and glass fiber first layer, a water repellant polybutylene terepthalate meltblown second layer, and a protective third layer providing structural support to the first and second layers. The second layer may be disposed between the first and third layers, or the first layer may be disposed between the second and third layers, and a protective fourth layer can be applied to either the first layer or the second layer for additional structural support if desired.

Typically, the cellulose and glass fiber first layer, which includes phenolic resin in the preferred embodiment, serves to retain particles that are finer than particles retained by the second meltblown layer.

Layers of the filter element can be arranged so that fluid flow occurs sequentially through the third, second, and first layers, through the first, second, and third layers, through the third, first, and second layers, or through the second, first, and third layers. The filtered fluid may be fuel, such as automotive fuel. A process of making a high efficiency, high capacity filter element suitable for meeting stringent cleanliness requirements is additionally described.

### BRIEF DESCRIPTION OF THE DRAWINGS

FIG. 1 is a cross section through a wall of a filter configured according to the present invention.

FIG. 2 is a view similar to that provided by FIG. 1 but in which a fuel flow direction is indicated by an arrow.

FIG. 3 is a view similar to that provided by FIG. 2, but in which fuel flow occurs in a direction opposite to that in the arrangement shown in FIG. 2.

FIG. 4 is another view similar to that provided by FIG. 2, but in which the multiple media layers are ordered differently.

FIG. 5 is a view similar to that provided by FIG. 4, but in which fuel flow occurs in an opposite direction through the media layers.

FIG. 6 shows both a plot of average initial filtration efficiencies for filter media according to the present invention as a function of particle size and an efficiency comparison for European grade filters and filter media according to the present invention.

### DETAILED DESCRIPTION OF THE INVENTION

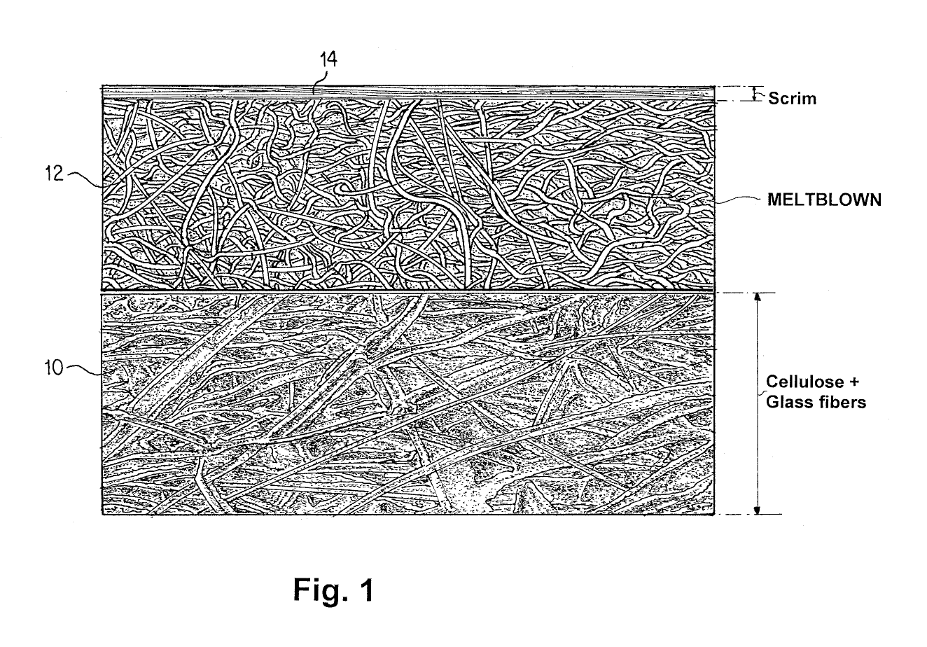

The cross sectional view provided by FIG. 1 illustrates that a laminated composite material arrangement according to the present invention has a first base layer 10 of cellulose and glass fibers, a meltblown second layer 12, and a third reinforcing protective woven polyester fabric scrim layer 14. The cellulose and glass fiber first layer 10 provides stiffness and efficiency, can be used as a hydrophilic or hydrophobic material if desired, and typically serves to retain the finest particles entrained in a flow of fuel through the filter wall. The meltblown second layer 12 is water repellant (hydrophobic), provides capacity, and typically retains coarser particles entrained in the flow of fuel. The layers 10 and 12, in this way, act to protect injection systems by filtering out contaminants as fuel passes through the layers of the overall filter element.

Although only one scrim layer 14 is shown in FIG. 1, scrims can be used on both sides of the filter wall if a particular application so dictates or when operating conditions so require. The scrim layer provides additional structural support and helps to meet stringent cleanliness requirements, as it retains remaining particles, glass, and cellulose fibers.

The base layer 10 is a wet-laid paper layer composed of a mixture of cellulose and glass fibers, impregnated with phenolic resin. The wet-laid paper is formed on a flat wire Fourdrinier paper machine, and the resin is applied using kiss and mull saturation.

The layer 12 is a polybutylene terepthalate (PBT) polymer meltblown. The layer 12 is produced using a typical meltblown production procedure, in which the PBT polymer is melted and extruded through a precise die to produce fine fibers. Following production of the layer 12, the meltblown and scrim are laminated to form a meltblown-scrim composite. The meltblown and scrim are laminated using a point-bonding method. During point-bonding, the scrim and meltblown are attached using a heated roll with spikes. The scrim and meltblown are laminated to the base layer on a Gravure laminator using a water-based adhesive.

The particular composition and production method noted provide both excellent performance and an advantageous cost savings potential.

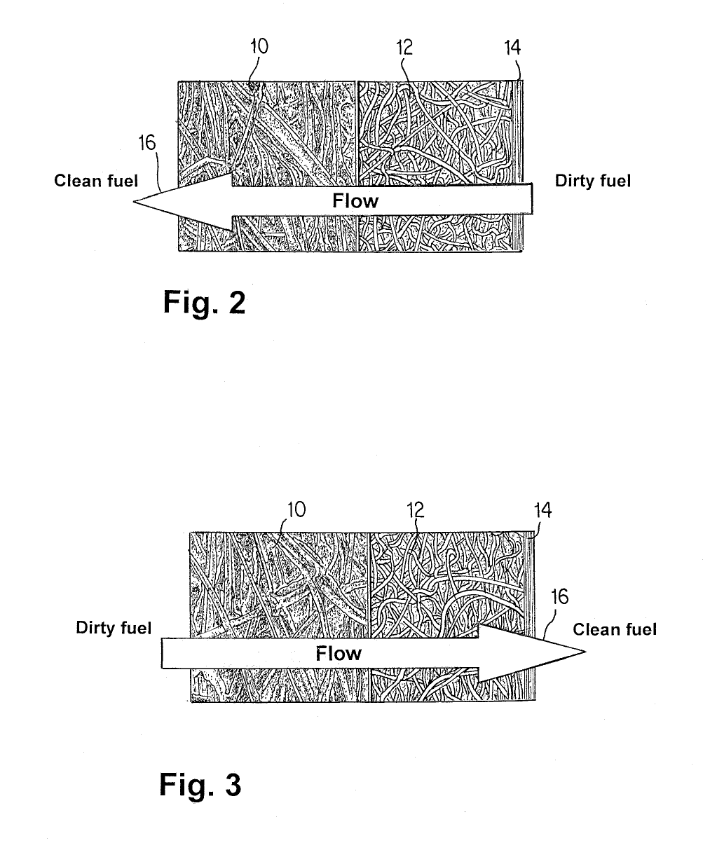

FIG. 2 is a cross section through a wall of a filter, similar to the view provided by FIG. 1, in which a fuel flow direction is indicated by an arrow 16. As FIG. 2 illustrates, flow of dirty fuel occurs initially through the scrim layer 14. Fuel flow then proceeds through the meltblown layer 12, and finally through the layer 10 of cellulose and glass fibers. Clean, filtered fuel emerges from the cellulose and glass fiber layer 10.

FIG. 3 is a view similar to that provided by FIG. 2, but in which the fuel flow indicated by the arrow 16 occurs in a direction opposite to that in the arrangement shown in FIG. 2. As FIG. 3 illustrates, flow of dirty fuel occurs initially through the layer 10 of cellulose and glass fibers. Fuel flow then proceeds through the meltblown layer 12, and finally through the scrim layer 14. Clean fuel emerges from the scrim layer 14.

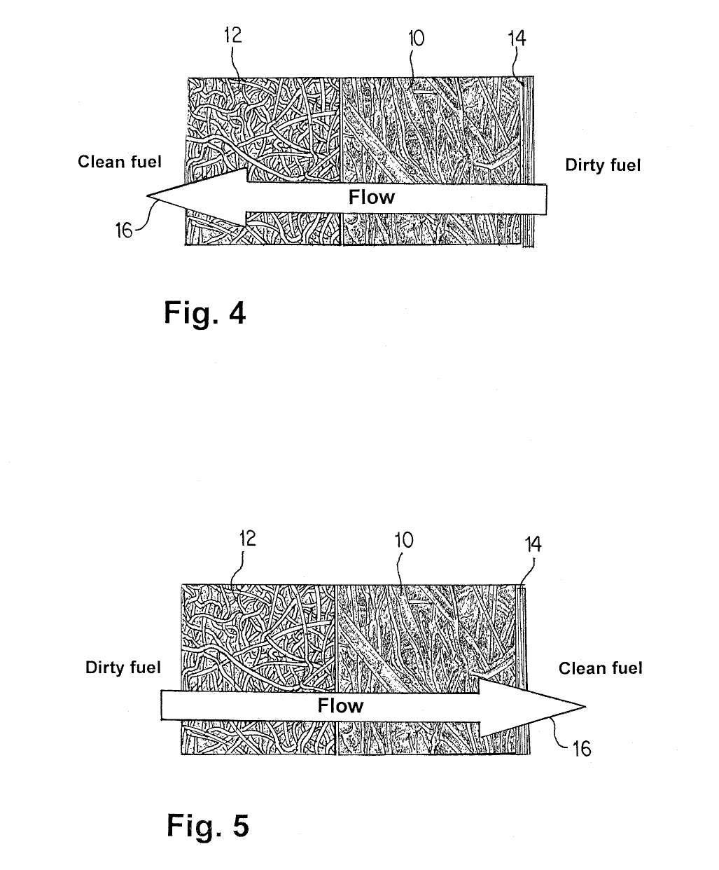

FIG. 4 is another view similar to that provided by FIG. 2, but in which the scrim layer 14 is secured to the cellulose and glass fiber layer 10 rather than to the meltblown layer 12. As indicated by the arrow 16, dirty fuel initially flows through the scrim layer 14. Fuel then travels through the cellulose and glass fiber layer 10, and finally through the meltblown layer 12. Clean fuel emerges from the meltblown layer 12.

FIG. 5 is a view similar to that provided by FIG. 4, but in which the fuel flow direction indicated by the arrow 16 occurs in a direction opposite to that in the arrangement shown in FIG. 4. As FIG. 5 illustrates, flow of dirty fuel occurs initially through the meltblown layer 12. Fuel flow then proceeds through the layer 10 of cellulose and glass fibers, and finally through the scrim layer 14. Clean fuel emerges from the scrim layer 14.

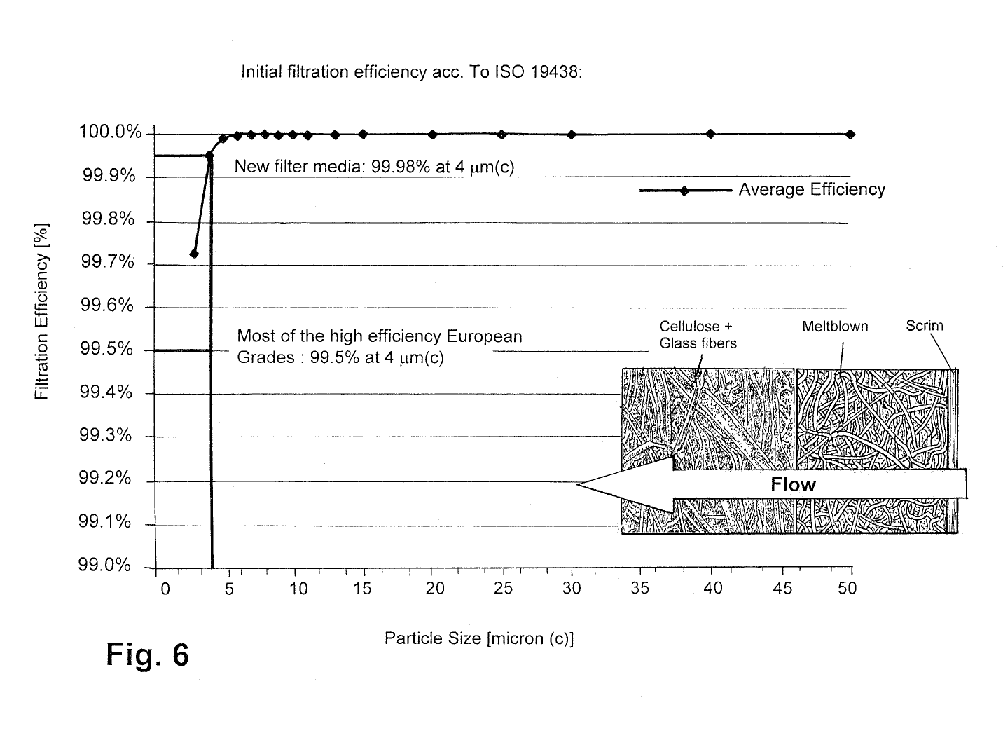

FIG. 6 shows a plot of average initial filtration efficiencies for filter media according to the present invention as a function of particle size (μm(c)) under parameters according to ISO 19438, as well as an initial efficiency comparison, at a 4 μm(c) particle size, of high efficiency European grade filters and the filter media according to the present invention under those parameters. As is evident from FIG. 6, at a 4 μm(c) particle size, an arrangement according to the present invention provides 99.98% filtration efficiency. This compares favorably to the 99.5% filtration efficiency provided by most high efficiency European grade filters under the specified conditions.

The filter media arrangements shown in FIGS. 1-5 are developed to address the extremely difficult NAFTA imposed requirements for cleanliness, particle separation efficiency, water separation efficiency, and dust holding capacity. Tests of the new cellulose and glass fiber with meltblown filter media according to ISO 4020-6.4 at 50 liters per hour show that these media achieve capacity three times that of European grades, and tests according to ISO 13353: 1994 show an efficiency η (or E) of 99.9% at 3-5 μm particle sizes and an 18 liter per hour flow rate. Most of the high efficiency European grades, by contrast, have corresponding efficiencies of 98.6%. For a flat sheet of material according to the invention, efficiency is 99.99% at 4 μm(c) particle size. Capacity achieved according to the present invention is 165 grams per square meter (g/m²).

While the invention is described above in the context of fuel filter applications, it is to be understood that the inventive concept is readily adaptable to other applications in which filtering of liquid or gaseous fluids is to be performed.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A high efficiency, high capacity filter element suitable for meeting stringent cleanliness requirements comprising:
a cellulose and glass fiber first layer,
a water repellant polybutylene terepthalate meltblown second layer, and
a protective third layer providing structural support to the first and second layers,
wherein the first, second, and third layers are joined together to define a laminated fluid filter element.

2. The filter element according to claim 1, wherein the second layer is disposed between the first and third layers.

3. The filter element according to claim 1, wherein the first layer is disposed between the second and third layers.

4. The filter element according to claim 1, further comprising a protective fourth layer providing the laminated fluid filter element with additional structural support.

5. The filter element according to claim 2, further comprising a protective fourth layer applied to the first layer providing the laminated fluid filter element with additional structural support.

6. The filter element according to claim 3, further comprising a protective fourth layer applied to the second layer providing the laminated fluid filter element with additional structural support.

7. The filter element according to claim 1, wherein the first layer serves to retain particles that are finer than particles retained by the second layer.

8. The filter element according to claim 1, wherein the cellulose and glass fiber first layer comprises phenolic resin.

9. The filter element according to claim 7, wherein the cellulose and glass fiber first layer comprises phenolic resin.

10. The filter element according to claim 1, wherein the layers are arranged so that fluid flow occurs sequentially through the third, second; and first layers.

11. The filter element according to claim 1, wherein the layers are arranged so that fluid flow occurs sequentially through the first, second, and third layers.

12. The filter element according to claim 1, wherein the layers are arranged so that flow occurs sequentially through the third, first, and second layers.

13. The filter element according to claim 1, wherein the layers are arranged so that flow occurs sequentially through the second, first, and third layers.

14. The filter element according to claim 1, wherein the fluid is fuel.

15. The filter element according to claim 14, wherein the fuel is automotive fuel.

16. A process of making a high efficiency, high capacity filter element suitable for meeting stringent cleanliness requirements comprising:
providing a cellulose and glass fiber first layer, a water repellant polybutylene terepthalate meltblown second layer, and a third protective layer for structurally supporting the first and second layers, and
joining the first, second, and third layers together to define a laminated fluid filter element.

17. The process of claim 16, wherein the cellulose and glass fiber first layer comprises phenolic resin.

18. The process of claim 16, wherein the first layer serves to retain particles that are finer than particles retained by the second layer.

19. The process of claim 16, wherein the second layer is disposed between the first and third layers.

20. The process of claim 16, wherein the first layer is disposed between the second and third layers.
